(19) United States
(12) Patent Application Publication
(10) Pub. No.: US 2024/0051771 A1
(43) Pub. Date: Feb. 15, 2024

(54) Gate valve, module with a valve and system for conveying of bulk goods with valves

(71) Applicant: Walter Kramer, Hünenberg See (CH)

(72) Inventor: Walter Kramer, Hünenberg See (CH)

(21) Appl. No.: 18/446,307

(22) Filed: Aug. 8, 2023

(30) Foreign Application Priority Data
Aug. 10, 2022 (DE) 10 2022 002 961.8

(51) Int. Cl. B65G 53/46; F16K 31/42; F16K 31/122

(52) U.S. Cl. CPC B65G 53/46; F16K 31/42; F16K 31/1221; F16K 3/0281

(57) ABSTRACT

A gate valve has a gate for opening and closing a conveyor line, which is connected to a piston. The piston delimits a pressure chamber within a housing which can be pressure-connected to the interior of the conveyor line. A module for producing a conveyor line of a system for conveying bulk material has a tube section from which a tubular crosspiece branches off, in which a valve is seated. The system for conveying bulk material has at least two senders containing the bulk material and at least one receiver receiving the bulk material, which are line-connected to one another by conveyor lines. The conveyor lines have at least one receiver collecting line, which has a line section running upwards, into which at least two transverse lines open, in each of which a valve is seated for opening and closing the line sections.

### CROSS-REFERENCE TO RELATED APPLICATION

This application claims the benefit of German Patent Application DE 10 2022 002 961.8, filed on Aug. 10, 2022, the contents of which is incorporated by reference in its entirety.

### TECHNICAL FIELD

The disclosure relates to a gate valve, a module for manufacturing a conveyor line of a system for conveying bulk material, and a system for conveying bulk material.

### BACKGROUND

Conveyor systems are known with which bulk material is conveyed from senders to receivers. The conveying takes place by means of a vacuum. The senders can each be connected to at least two receivers via a conveyor line. Blockages can occur at the outlets from the conveyor lines to the receivers, which can lead to problems with the conveying.

It is also known to lead the sender lines to a distribution station, from which one line leads to each receiver. The bulk material to be conveyed from a sender to a receiver is selected manually by reconnecting conveyor hoses or automatically by sliding or rotating a part of the conveyor lines.

### SUMMARY

The disclosure describes a gate valve, and an associated module and system which are designed such that a bulk material can be reliably conveyed from a selected sender to a selected receiver.

The gate valve is characterized in that its gate is automatically adjusted as a function of the prevailing pressure in the conveyor line. To this end, the gate is connected to a piston which delimits a pressure chamber within a housing. When it is open, a switching valve in the pressure transmission connection between the conveyor line and the pressure chamber releases the pressure connection between the conveyor line and the pressure chamber, and then the pressure in the conveyor line also prevails in the pressure chamber. Pressure is to be understood as meaning a vacuum (below ambient) or a positive (above ambient) pressure. During suction conveying, a vacuum is present in the pressure chamber, which causes the piston to be displaced by the suction effect. Since the piston is connected to the gate, the gate is adjusted accordingly from its closed position to its open position, so that the material can flow through the conveyor line.

During pressure operation, the piston is pushed away by the pressure prevailing in the pressure chamber, as a result of which the gate connected to it also moves from the closed to the open position.

The gate is adjusted in good time before the material to be conveyed flows through the conveyor line. This ensures that the material can flow unobstructed through the conveyor line.

The gate is advantageously connected to the piston by at least one connecting piece. The connecting piece is preferably a piston rod that can be easily attached to the piston. The gate can be arranged at a sufficient distance from the piston via the connecting piece, so that the gate can be adjusted without problems.

In a preferred embodiment, at least one opening to which a first pressure transmission line is connected opens into the pressure chamber.

This pressure transmission line is preferably connected to a switching valve with which the passage through the pressure transmission line can be opened or closed.

In a preferred embodiment, the switching valve is located within a valve housing. The switching valve can be easily installed there and also easily removed if necessary, e.g. for repairs.

A second pressure transmission line, which is provided for connection to the conveyor line, is advantageously connected to the switching valve. The second pressure transmission line is connected to the interior of the conveyor line, so that the pressure prevailing in the conveyor line also prevails in the second pressure transmission line.

If a conveying cycle is to take place, the switching valve is opened so that the pressure prevailing in the second pressure transmission line prevails in the pressure chamber via the open switching valve and the first pressure transmission line.

In order to connect the second pressure transmission line, the conveyor line is advantageously provided with an opening, by which the pressure prevailing in the conveyor line can be transmitted into the pressure chamber.

The switching valve is preferably a solenoid valve that can be controlled in a simple manner, has a compact design and can be easily accommodated in the valve housing.

It is advantageous to monitor the two end positions of the gate. For this purpose, limit switches are provided in an advantageous embodiment, which can interact with the gate when it assumes its open and/or its closed position. The limit switches can be proximity switches.

It is possible to provide the gate with at least one stop element which comes into contact with a counter-stop in the respective end position of the gate.

If the gate valve is installed in a conveying system in a vertical or almost vertical position, the gate is returned to its closed position very simply by the fact that the conveying is stopped. As a result, there is no longer any pressure in the conveyor line. The pressure difference between the conveyor line and the pressure chamber is eliminated, so that the piston is pushed down under its own weight, causing the gate to move from the open to the closed position. Because the gate is connected to the piston, the weight of the gate also acts on the piston and its retracting motion.

If the gate valve is installed in an inclined or even in a horizontal position, then a restoring force advantageously acts on the piston in the open position of the gate.

It is generated in that at least one pressure medium is accommodated in the pressure chamber, which exerts the restoring force on the piston. The pressure medium is advantageously a compression spring, which is adjusted in such a way that the piston can be displaced under the conveying pressure in the conveyor line, in order to slide the gate into its open position.

The restoring force can be generated by at least one restoring element that acts on the gate.

Such a restoring element is advantageously an elastically stretchable pull rope or a pull rope that carries a weight. The elastically stretchable pull rope is stretched elastically when the gate is in the open position, as a result of which a restoring force acts on the piston via the gate. The pulling force of the pull rope is set in such a way that the piston can be reliably moved under the respective operating pressure prevailing in the conveyor line. This also applies in the event that a weight is hanging on the pull rope, which loads the gate and thus the piston in the restoring direction.

The module according to the invention is used to put together the conveyor line of a conveying system for bulk material. The module has a tube section from which a tubular crosspiece with a switching valve seated therein branches off. To produce the conveyor line, two or more modules are placed together with their tube sections, resulting in a continuous conveyor line. The crosspieces are advantageously directed obliquely upwards from the tube sections counter to the conveying direction, so that any material in the crosspieces can get down into the tube section after the end of a conveying cycle. It will be taken from there in the next conveying cycle. This reliably prevents blockages in the conveyor line.

In the system according to the disclosure, the conveyor lines between the sender and the receiver have at least one receiver collecting line. It has an upward, for example vertical, line section into which at least two transverse lines open. In each of them there is a gate valve for opening and closing the line section. The transverse lines are at an acute angle to the line sections running from top to bottom. As a result, the bulk material to be conveyed can fall down into the line section at the end of a conveying cycle. There, the bulk material can be taken along in the next conveying cycle and fed to the respective receiver.

The line section running upwards is achieved in an advantageous manner in that two or more modules are assembled in a fluid-tight manner with their tube sections. When assembled, these tube sections form the line section of the receiver collecting line.

The number of modules determines the desired number of senders from which the bulk material is to be sent to the receivers.

A draining suction module that has no connection to a sender is preferably arranged at the upper end of the transverse line. As a result, after each conveying cycle, the receiver line can be drained and cleaned up to the receiver, which is particularly necessary when changing materials.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

The invention is explained in more detail based on embodiments depicted in the drawings.

FIG. 1 shows a schematic representation of a system for conveying bulk material in suction operation.

FIG. 2 shows, in a representation corresponding to FIG. 1, a system for conveying bulk material in pressure operation.

FIG. 3 and FIG. 4 show, in representations corresponding to FIGS. 1 and 2, further embodiments of systems for conveying bulk material.

FIG. 5 shows an enlarged view of the arrangement of modules, each of which has a gate valve.

FIG. 6 shows a further embodiment of a module with a gate valve in an illustration similar to FIG. 5.

FIG. 7 shows two modules as in FIG. 6 that are arranged one above the other and are fluidly connected to one another.

FIG. 8 shows a perspective view of a gate valve.

FIG. 9 is a view in the direction of arrow IX in FIG. 8.

FIG. 10 is a view in the direction of arrow X in FIG. 8.

FIG. 11 shows a section along the line A-A in FIG. 10 with the gate valve in the closed position.

FIG. 12 shows the gate valve according to FIG. 11 in the open position.

FIG. 13 shows a second embodiment of a gate valve in an illustration corresponding to FIG. 12.

### DETAILED DESCRIPTION

FIG. 1 shows a system for conveying bulk materials. The system has, for example, five senders A to E, which are designed as silos, for example, in which the bulk material is located. Bulk materials are understood to include all flowable materials that can be transported by means of a gaseous medium, in particular air, such as granules, powders and the like.

In the illustrated embodiment, the senders A, B have a smaller capacity than the senders C to E. All senders can have the same capacity or different capacities.

Each sender A to E has a cylindrical casing 1, for example, which merges into a downwardly tapering casing 2 at the lower end. At the lower end of the casing 2 there is an outlet opening 3 which can be closed by a valve 4. Such a design is provided for pressure conveying of the bulk material.

In the case of vacuum or suction conveying, the casing 2 has no outlet opening. Instead, a suction tube protrudes through the casing 2 into its interior, with which the bulk material can be suctioned off.

A sender line 5 to 9 is connected to the outlet opening 3 or to the suction tube of each sender A to E. They can be connected to receiver lines 10 to 12 in order to selectively feed the bulk material in senders A to E to receivers 1 to 3. For example, they sit on processing machines with which the supplied bulk material is processed accordingly.

The sender lines 5 to 9 are permanently fluidly connected to the receiver lines 10 to 12. In this case, these lines are coupled to one another in such a way that the receivers 1 to 3 can be coupled to different senders A to E.

An example of the fluid connection between sender lines 5-9 and receiver lines 10-12 is given below. However, this embodiment is not to be construed as limiting.

The sender line 5 is connected to the receiver line 12. A transverse line 13 branches off from the sender line 5 and connects the sender line 5 to the receiver line 10. In the sender line 5 and in the transverse line 13 there is a gate valve 14 (hereinafter referred to as valve) with which the sender line 5 and the transverse line 13 can be opened and closed.

The sender line 6 is connected to the receiver line 12. The sender line 6 is also connected to the receiver lines 11, 10 via transverse lines 15, 16. A valve 14 is arranged in each of the sender line 6 and in the transverse lines 15, 16.

The sender line 7 is connected to the receiver line 11. The valve 14 is located in the sender line 7.

The sender line 8 is connected to the receiver line 11 and via a transverse line 17 to the receiver line 10. A valve 14 is arranged in each of the transverse line 17 and in the sender line 8.

Finally, the sender line 9 connects to the receiver line 10 and is provided with the valve 14.

With the help of the valves 14, it is easily possible to fill the receivers 1 to 3 with the respectively desired bulk material from the senders A to E. In the example shown, receiver 1 is assigned to senders A, B, D and E. When the valve 14 is open, the bulk material can be supplied from the sender A via the sender line 9 and the receiver line 10. When the valve is open the bulk material in the sender B can be conveyed via the sender line 8 and the transverse line 17 into the receiver line 10 and from there to the receiver 1. In this case, of course, the valve 14 located in the sender line 9 is closed.

The bulk material from the sender D can be fed to the receiver 1 via the sender line 6 and the transverse line 16. The valve 14 seated in the transverse line 16 is then open.

The bulk material from the sender E can be conveyed via the sender line 5 and the transverse line 13 into the receiver line 10 and from there to the receiver 1, with the valve 14 seated in the transverse line 13 being open.

All lines not involved in the conveying from the sender to the receiver are shut off by the valves 14, so that only one type of bulk material can get into the respective receiver 1 to 3.

The receiver 2 is assigned to senders B, C and D.

The bulk material in the sender B can reach the receiver line 11 via the line 8 and from there into the receiver 2. The valve 14 seated in the sender line 8 is then open.

With the valve 14 being open the bulk material in the sender C can also be fed to the receiver 2 via the sender line 7 and via the receiver line 11.

The sender D can also be fluidly connected to the receiver line 11 and thus to the receiver 2 via the sender line 6 and the transverse line 15.

The receiver 3 is assigned to senders D and E. The bulk material from the sender D can be fed to the receiver 3 via the sender line 6 and the receiver line 12.

The sender E can also be connected to the receiver 3 via the sender line 5 and the receiver line 12.

The conveyor function of the system is simple. A respective sender A to E is assigned to each receiver 1 to 3 by opening the corresponding valve 14.

A suction line 18 to 20 is connected to each of the receivers 1 to 3 and is connected to a suction source 21. A valve 14 is seated in each of the suction lines 18 to 20 so that the receivers 1 to 3 can be separated from the suction source 21 as desired.

The suction source 21 is preceded by a valve 14′, with which the suction connection between the suction source 21 and all receivers 1 to 3 can be separated in the closed position. At least one filter 22 can be connected upstream of the suction source 21.

By the at least one suction source 21, the bulk material is suctioned out of the respective senders A to E and fed to the respective receivers 1 to 3. With each suction cycle, the corresponding assigned valve 14 is opened.

If, after the end of production, receivers 1 to 3 are to receive a different bulk material, the corresponding valves 14 are switched over in such a way that the other material from the desired sender A to E can be fed to the corresponding receiver 1 to 3.

After each conveying process from a sender to a receiver, the air flow is interrupted in a known manner.

So that a receiver 1 to 3 can be assigned different materials from the senders A to E, at least two inputs are provided in the respective receiver line 10 to 12. The receiver lines 10 to 12 run upwards in the area where the sender lines or the transverse lines connect, in the exemplary embodiment vertically (receiver collecting lines 10a to 12a), so that the bulk material is conveyed from top to bottom in this area.

The vertical receiver collecting lines 10a through 12a are composed of modules each having a vertical tube segment, a vertical tube segment connected thereto, and the valve 14 disposed in said transverse tube segment. These modules are explained in more detail below.

The receiver collecting lines 10a to 12a can also run obliquely and accordingly be arranged at an angle to the vertical.

The number of these modules determines the desired number of senders A to E whose material is to be assigned to the receivers 1 to 3.

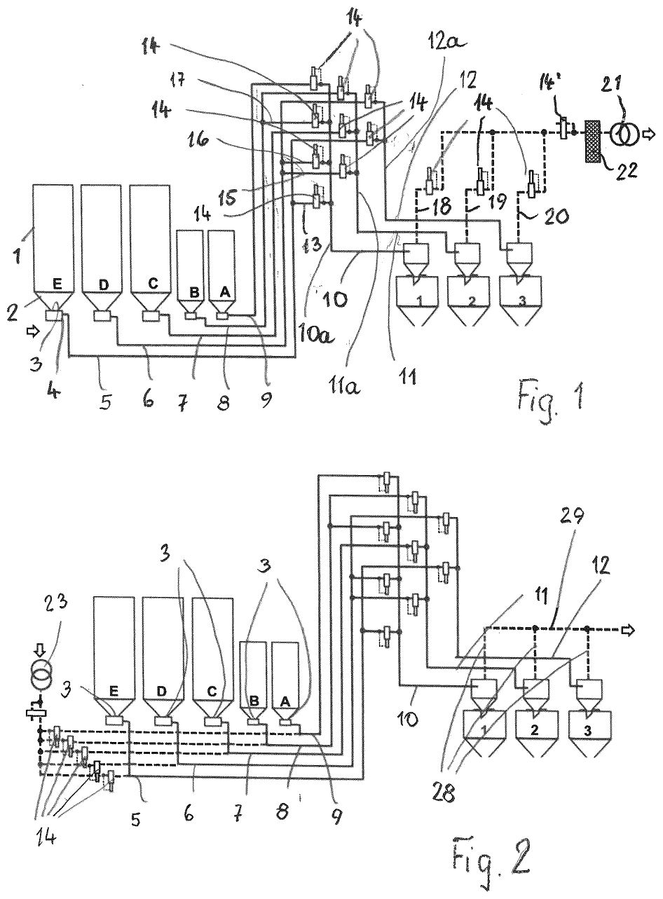

The system according to FIG. 2 is designed in the same way as the system according to FIG. 1 with regard to the linking of the senders A to E with the receivers 1 to 3. However, the system according to FIG. 2 is a pressure conveying system in which a pressure source 23 is used instead of a suction source. It conveys the bulk material from senders A to E under pressure through the corresponding lines to the receivers 1 to 3.

While in the system according to FIG. 1 the bulk material is conveyed by means of a vacuum from the senders A to E to the receivers 1 to 3, this is done in the system according to FIG. 2 by positive pressure.

The sender lines 5 to 9 are each connected to the pressure source 23, which is preferably a compressed air source. In each sender line 5 to 9 there is a valve 14 with which each sender line 5 to 9 can be separated from the pressure source 23. The valves 14 are located in the area between the respective outlet opening 3 of the senders A to E and the pressure source 23.

With regard to the assignment of the senders A to E to the receivers 1 to 3, reference is made to the explanations relating to the system according to FIG. 1.

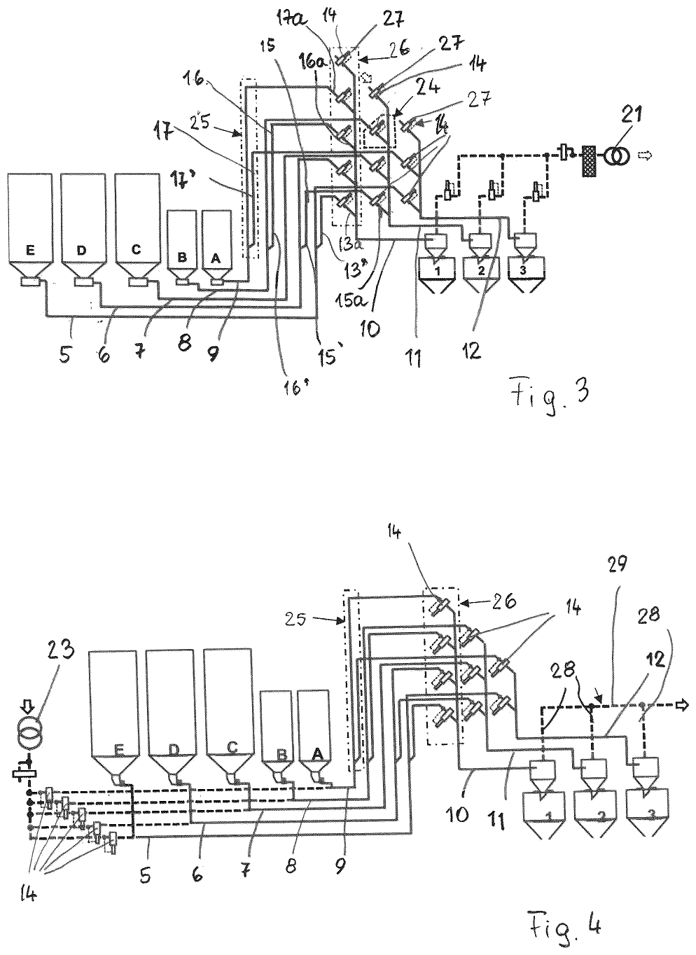

The systems according to FIGS. 3 and 4 are basically the same as the systems according to FIGS. 1 and 2. The system according to FIG. 3 is a suction conveying system and the system according to FIG. 4 is a pressure conveying system.

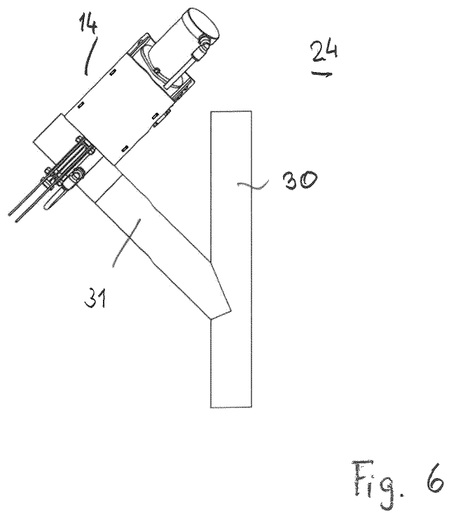

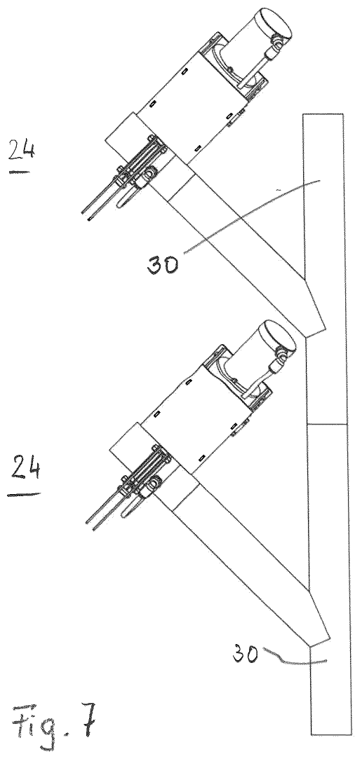

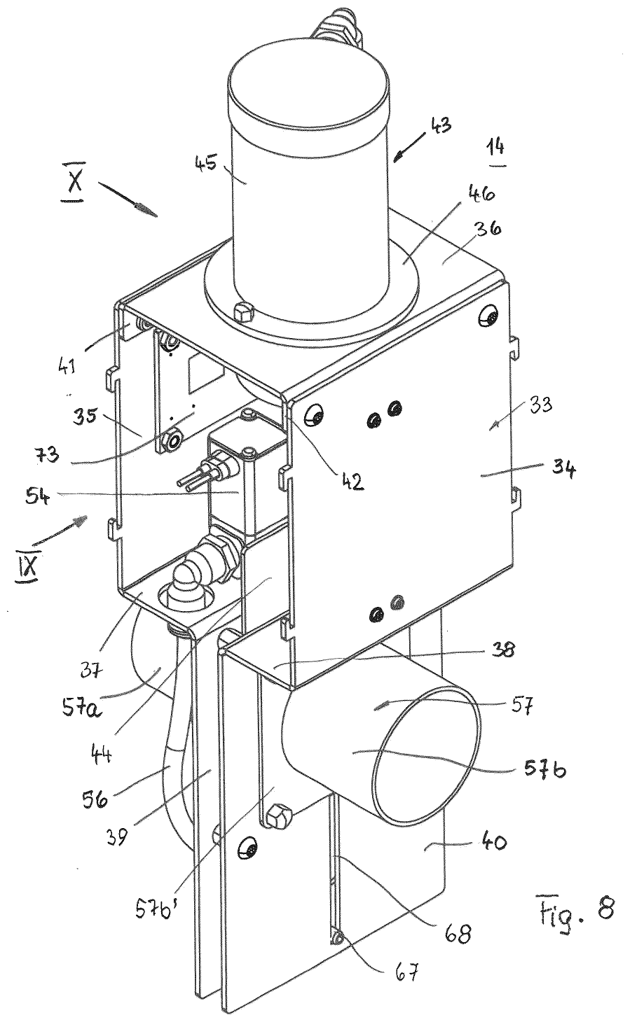

A dashed line in FIG. 3 indicates a module 24 which will be described in detail with reference to FIGS. 6 and 7. The modules 24 are plugged together in a fluid-tight manner when the system is set up.

As in the previous embodiments, the systems according to FIGS. 3 and 4 are constructed by way of example in such a way that has the senders A, B, D and E are assigned to the receiver 1, the senders B, C and D are assigned to the receiver 2, and the senders D and E are assigned to the receiver 3.

In contrast to the embodiments according to FIGS. 1 and 2, the valves 14 are located in sloping sections of the transverse lines 13, 15 to 17.

The transverse lines 13, 15 to 17 each have a line section 13′, 15′ to 17′ running parallel to the sender line 5 to 9, which, via a line section running perpendicular to it, transitions into the downwardly sloped line section 13a, 15a to 17a that include the valve 14.

The sender line 9 with the associated line section 17′ of the transverse line 17 forms a sender distribution line 25 oriented from bottom to top, which is illustrated in FIG. 3 by a dot-dash line. All other sender lines 5 to 8 with the transverse lines 13′, 15′, 16′ each form a further sender distribution line aligned from bottom to top.

The receiver lines 10 to 12 with the adjoining sloped line sections having the valves 14 each form a receiver collecting line 26, as is indicated for the receiver line 10 with the sloped line sections connected thereto by a dot-dash line. Since three receiver lines 10 to 12 are provided in the exemplary embodiment, there are accordingly also three receiver collecting lines.

The receiver lines 10 to 12 are each provided with an draining suction module 27 at the free end. Each draining suction module 27 has a valve 14 that can be opened for the draining suction process and is not connected to a sender line.

In the pressure conveying system according to FIG. 4, the sender distribution lines 25 and the receiver collecting line 26 are provided in the same way. As in the previous embodiment, only one distribution or collecting line is shown.

As in the exemplary embodiment according to FIG. 2, an exhaust air line 28 each leads from the receivers 1 to 3 to the outside, via which the exhaust air can be discharged.

The exhaust air lines 28 are advantageously connected to a common collecting line 29.

The exhaust air lines 28, 29 can optionally be provided with valves or check valves in order to be able to close these lines if necessary.

The connection between the senders A to E and the receivers 1 to 3 is essentially the same as in the system according to FIG. 3. Since the system according to FIG. 4 is a pressure conveying system, in contrast to the suction conveying system according to FIG. 3, no draining suction modules are provided. While in the system according to FIG. 3 the bulk material located in the senders A to E is suctioned off by means of the suction source 21 and fed to the receivers 1 to 3, in the embodiment according to FIG. 4 the bulk material is fed to the receivers 1 to 3 by a pressure medium.

According to the embodiments according to FIGS. 1 and 3, after each conveying cycle the material still present in the sender distribution line 25 falls downwards. The material present in the receiver collecting line 26 also falls downwards. This residual material is conveyed in a next conveying cycle. This prevents such residual material from forming so-called plugs in the conveyor lines, which under certain circumstances could lead to the conveyor line becoming clogged.

If, in the suction conveying system according to FIG. 3, the draining suction modules 27 at the uppermost point of the receiver collecting lines 26 are used, which do not have a connection to one of the senders A to E, after each suction process (conveying cycle), the receiver line 10 to 12 can be sucked empty and thus cleaned up to the separator of the receiver 1 to 3. This is necessary above all when changing materials.

These advantages are also given in the case of the pressure conveying system according to FIG. 4. The air stream flows through the lines 5 to 12 in the same way as in the suction conveying system according to FIG. 3. In the case of the pressure conveying system, too, the sender distribution lines 25 and receiver collecting lines 26, which run upwards, preferably vertically, ensure that the material still in these lines falls down after each conveying cycle and is caught again in the next conveying cycle and conveyed out of the lines.

In all the embodiments described according to FIGS. 1 to 4, the bulk material is conveyed in the receiver lines 26 from top to bottom. A conveying from top to bottom is to be understood as meaning both a vertical conveying and a conveying that takes place at an angle obliquely to the vertical. This ensures that the remaining bulk material that remains in the lines at the end of the conveying process is carried along in the next conveying cycle. In this way, clogging of the corresponding lines by residual material left behind after the end of the conveying cycle is avoided.

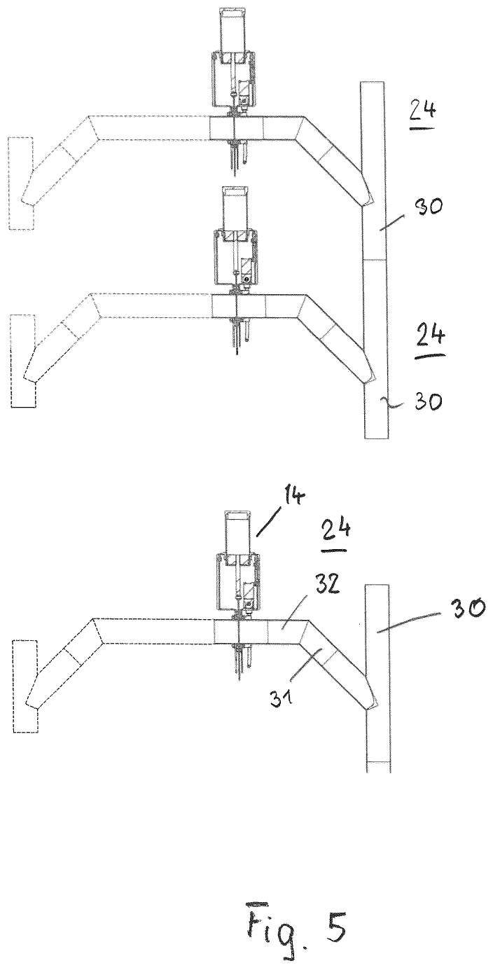

FIG. 5 shows an example of a first embodiment of a module 24. It has a tube section 30 from which a crosspiece 31 branches off obliquely upwards. At the free end it merges into an end section 32 in which the valve 14 is arranged and which runs perpendicularly to the tube section 30.

As shown in FIG. 5 by way of example, two modules 24 can be plugged together with the tube sections 30. The tube sections 30 form parts of the receiver collecting lines 26 in the system.

The module 24 according to FIGS. 6 and 7 also has the tube section 30 which runs vertically in the installed position and from which the crosspiece 31 branches off obliquely upwards. The valve 14 is located at the free end of this crosspiece 31. This type of module is used in the systems shown in FIGS. 3 and 4. The modules 24 are plugged onto one another with the tube sections 30 (FIG. 7), which form the receiver collecting line 26 (FIGS. 3 and 4).

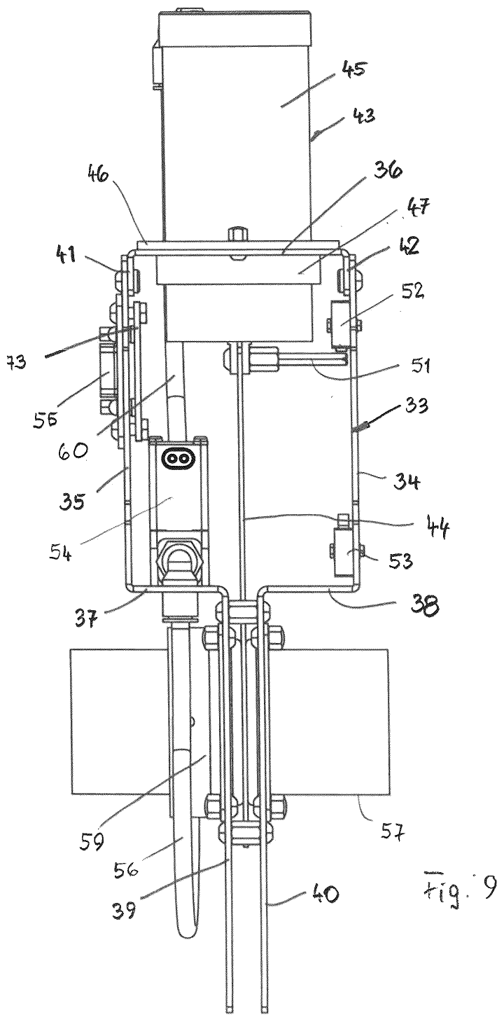

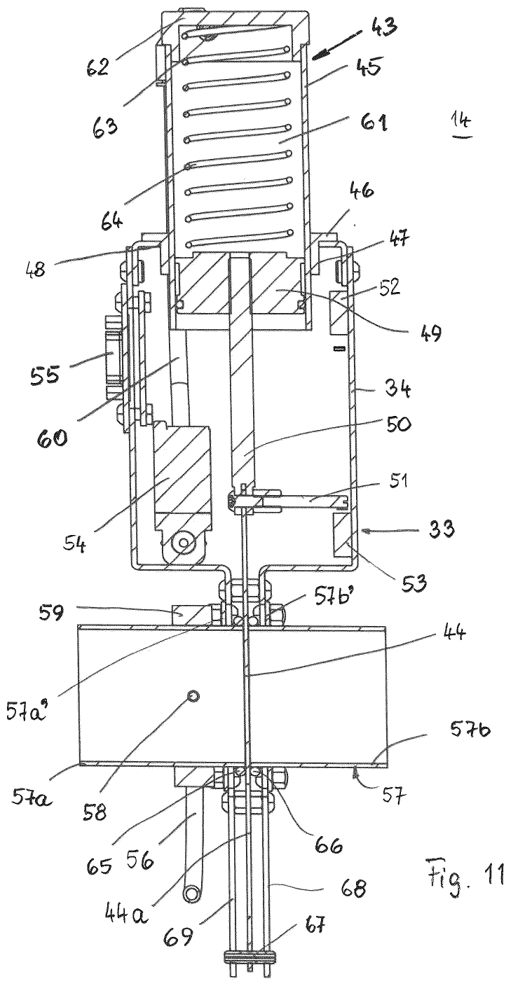

The valve 14 is described in detail with reference to FIGS. 8 to 12. It has a housing 33 which has side walls 34, 35 arranged parallel to one another. The side walls 34, 35 are connected to one another by an upper wall 36 at their upper ends.

At the opposite end, the side walls 34, 35 are angled in such a way that they merge into bottom sections 37, 38 which are at the same height and parallel to the upper wall 36 and perpendicular to the side walls 34, 35. The bottom sections 37, 38 merge into holding parts 39, 40 which extend downwards at right angles and which run parallel to one another at a distance.

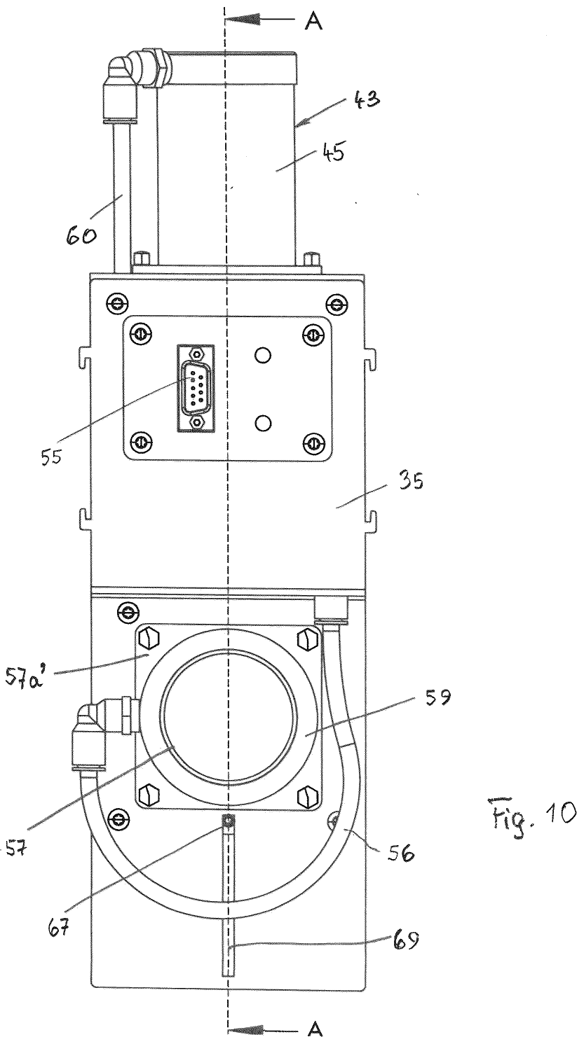

To form the side walls 34, 35, the bottom sections 37, 38, and the holding parts 39, 40, two metal sheets are advantageously used, which are bent in the manner described. This design is shown in particular in FIGS. 8 and 9.

The upper wall 36 is advantageously connected to the side walls 34, 35 as a separate component. The upper wall 36 is advantageously bent in a U-shape and is firmly connected, for example screwed, with its legs 41, 42 to the inside of the side walls 34, 35.

A drive 43 is fastened to the upper wall 36, with which a plate-shaped gate 44 for opening and closing the corresponding line 57 can be adjusted. The gate 44 has a passage opening 44a, the diameter of which corresponds to the inner diameter of the line 57.

The drive 43 has a housing 45 which projects through the upper wall 36 into the housing 33. The cylindrical housing 45 is fastened to, preferably screwed on, the outside of the upper wall 36 with an annular flange 46. The annular flange 46 is part of a retaining bushing 47 which protrudes into the housing 33 through an opening 48 (FIG. 11) in the upper wall 36. The retaining bushing 47 is attached to the outside of the housing 45.

In the cylindrical housing 45, a piston 49 is slidably mounted (FIG. 11). The gate 44 is firmly connected to the piston 49 via a connecting piece 50. An arm 51 protrudes transversely from the connecting piece 50, extends close to the side wall 34 of the housing 33, and interacts with two limit switches 52, 53 which are provided on the inside of the side wall 34.

The limit switches 52, 53 can be arranged on a circuit board 73 (FIGS. 8 and 9), which is arranged on the side wall 35 of the housing 33, for example, in a departure from the exemplary embodiment shown.

A solenoid valve 54 is accommodated in the housing 33 of the valve 14 and is suitably fastened, for example, to the bottom section 37.

An interface 55 for actuating the solenoid valve 54 is located on the outside of the side wall 35 of the housing 33.

The solenoid valve 54 is connected by a connecting hose 56 as a pressure transmission line to the respective conveyor line, which is denoted by 57 in FIGS. 8 to 12.

The connecting hose 56 is fluidly connected to the interior of the conveyor line 57, which has an opening 58 (FIG. 11) to which the connecting hose 56 is connected. It is held on the conveyor line 57, for example by means of a clamp 59 (FIG. 11).

The solenoid valve 54 is fluidly connected to a cylinder chamber 61 in the housing 45 via a further connecting hose 60 as a pressure transmission line. The cylinder chamber 61 is located in the area between the piston 49 and a cover 62 which closes the cylinder chamber 61 airtight. The air inlet 63 is near the bottom of the cover 62 (FIG. 11).

The piston 49 also closes the cylinder chamber 61 almost airtight so that it can be moved downwards without any problems.

In the illustrated embodiment, at least one compression spring 64 is accommodated in the cylinder chamber 61, which loads the piston 49 in the direction of the closed position of the gate 44 and which is supported on the cover 62. The compression spring 64 or a corresponding other pressure medium is not required for the function of the valve 14 if the valve 14 is installed in a vertical or in a nearly vertical position. Then, due to its weight as well as the weight of the connecting piece 50 connected to it and of the gate 44, the piston 49 moves downward to the end position shown in FIG. 11, in which the gate 44 closes the passage of the bulk material through the conveyor line 57.

For the purpose of sealing, ring-shaped sealing elements 65, 66 rest on both sides of the gate 44, which are formed, for example, by O-rings and seal the passage in the conveyor line 57 for the gate 44 in an airtight manner. The sealing elements 65, 66 rest between the holding parts 39, 40 on the ends of the tube sections 57a, 57b located between the holding parts 39, 40.

A tube section 57a, 57b is fastened to the outer sides of the holding parts 39, 40 facing away from one another.

If the solenoid valve 54 is closed, the gate 44 remains in its closed position shown in FIG. 11 due to its own weight (in addition to the connecting piece 50 and the piston 49). The piston 49 accordingly assumes its lower position. The arm 51 of the connecting piece 50 is located at the lower limit switch 53 (FIG. 11).

At the lower end a stop 67 passes through transversely through the gate 44 (FIG. 11). It is designed in the form of a pin, for example, and protrudes into longitudinal slots 68, 69 which are provided in the two holding parts 39, 40. They lie at a distance on both sides of the gate 44, so that its displacement movement is not impaired by the holding parts 39, 40.

When the gate 44 is in the closed position, the stop 67 rests against the lower end of the longitudinal slots 68, 69 (FIGS. 8 and 11).

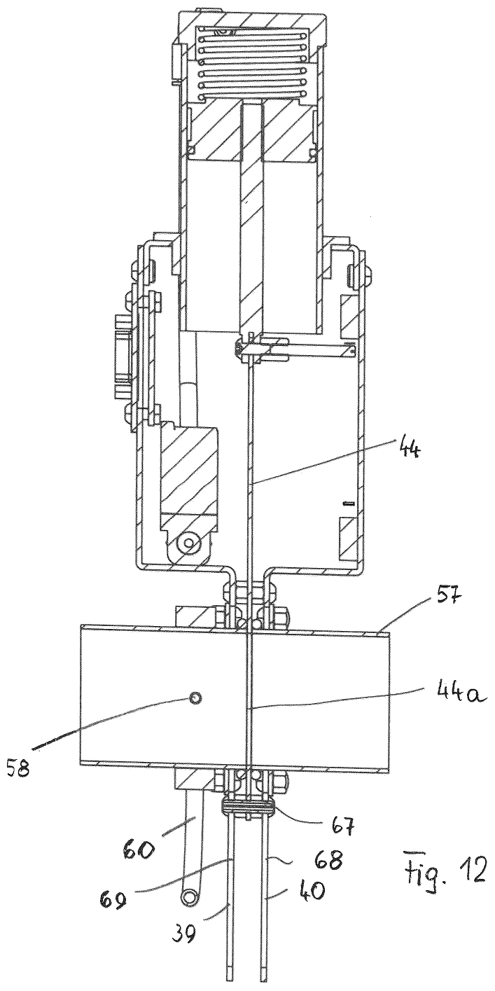

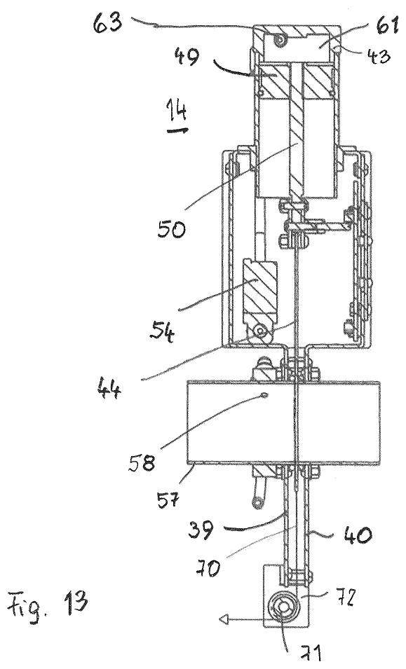

If the solenoid valve 54 is opened by a conveyor system control and a vacuum is built up in the conveyor line 57, the conveying process starts. A vacuum is also created in the cylinder chamber 61 of the drive 43 via the connecting hoses 56, 60, which causes the piston 49 to be pulled upwards against the force of the compression spring 64. As a result, the gate 44 is pulled upwards into its open position (FIG. 12), in which the passage opening 44a releases the passage through the line 57.

The gate 44 is already pulled up before the material is conveyed. In the connecting line 56, 60 from the conveyor line 57 to the cylinder chamber 61 there is practically no air flow during the conveying process, since the vacuum in the conveyor line 57 is the same as the vacuum in the cylinder chamber 61 as a result of the described fluid connection.

If the valve 14 is used for pressure conveying (FIGS. 2 and 4), then the function is the same as for the described suction conveying. Only the valve 14 is then installed in the reverse position, as can be seen from a comparison of FIGS. 1 and 2 or 3 and 4. In pressure conveying (FIGS. 1 and 3), the valves 14 extend upwards from the respective line. In pressure conveying (FIGS. 2 and 4), the valves 14 extend downward from the respective line. During pressure conveying, the pressure in the conveyor line 57, which is effective in the cylinder chamber 61 via the described connection line 56, 60, ensures that the piston 49 is displaced in such a way that the gate 44 assumes its open position.

In this case, the passage opening 44a is located at a different point on the gate 44, so that it can open or close the line 57. While the passage opening 44a is provided in the area of the gate 44 facing away from the piston 49 when used for suction conveying, the passage opening 44a is located in the area of the gate 44 adjacent to the piston 49 when the valve 14 is used for pressure conveying.

The two end positions of the gate 44 are ensured in a simple manner in that the stop 67 comes to rest on the two ends of the longitudinal slots 68, 69.

The arm 51 projecting transversely from the connecting piece 50 interacts with the respective limit switch 52, 53 in the open and in the closed position. They are advantageously designed as proximity switches that can be used to monitor whether the valve 14 is open or closed. In the respective end position of the gate 44, a corresponding switching signal is supplied via the limit switches 52, 53, which can be used to reliably determine that the gate 44 is in its open or closed position.

The compression spring 64 is not required when the valve 14 is installed vertically because the gate 44 always reaches its closed position due to the described dead weight when the solenoid valve 54 is not open. Since the compression spring 64 is compressed when the gate 44 is in the open position (FIG. 12), it assists the downward movement of the piston 49 when the gate 44 is to be moved to its closed position.

However, if the valve 14 is installed obliquely within the system, for example, then the compression spring 64 ensures that the piston 49 is reliably displaced in order to displace the gate 44 from its open position into its closed position. In particular, if the valve 14 should be installed horizontally, the compression spring 64 is required.

The compression spring 64 is advantageously slightly prestressed when the piston 49 is in a position in which the gate 44 closes the conveyor line 57. The spring force is adjusted in such a way that the piston 49 can be displaced in any case if the gate 44 has to be displaced into its closed position.

Instead of the compression spring 64, any other suitable pressure medium can also be used, for example a pneumatic medium.

The valves 14 can be actuated in a simple manner with the solenoid valve 54, so that the bulk material can be conveyed from the respective sender A to E to the respective receiver 1 to 3. By actuating the solenoid valves 54, the necessary valves 14 can be opened in the manner described. Only those valves 14 are opened which are required for conveying the bulk material from the selected sender A to E to the selected receiver 1 to 3. In this way, in particular, it is also easy to change the sender and/or the receiver and/or the type of bulk material.

The valve 14 has a simple structural design and can be manufactured inexpensively. By means of the connecting hoses 56, 60, a simple yet reliable fluid connection between the cylinder chamber 61 and the conveyor line 57 is ensured when the solenoid valve 54 is open.

FIG. 13 shows another embodiment of a valve. It is designed in such a way that it can be installed obliquely or horizontally in the respective conveyor line without using a pressure medium, such as the compression spring 64 of the previous exemplary embodiment.

The gate 44 is connected to at least one restoring element 70 which, in the exemplary embodiment, is a pull rope which is deflected via a deflection roller 71. The restoring element 70 is provided, for example, with a weight (not shown) with which a restoring force is exerted on the gate 44 when the latter is in its open position shown in FIG. 13.

The restoring force can also be generated in that the restoring element 70 is a rubber cable or the like, which is under tension when the gate 44 is in the open position.

The deflection roller 71 is rotatably mounted on a carrier 72 which is attached to the free lower end of the holding parts 39, 40.

Otherwise, the valve 14 is of the same design as the previous embodiment.

FIG. 13 shows the piston 49 in its upper position within the housing 43. The conveyor line 57 is released by the gate 44 so that the bulk material can be conveyed. In the illustrated embodiment, the bulk material is transported by a suction conveying process. It is displaced in the described manner as a result of the vacuum in the conveyor line 57 to the upper position shown in FIG. 13. The same pressure acts in the cylinder chamber 61 via the connecting hoses 56, 60 as in the conveyor line 57, which is a vacuum in the case of suction conveying. In the manner described, it causes the piston 49 to be displaced into the upper position.

The restoring force acting via the restoring element 70 on the gate 44 and thus on the piston 49 is adjusted in such a way that the piston 49 can be displaced by the vacuum pressure effect.

At the end of the conveying process, the piston 49 is pushed down again under its own weight, supported by the weight of the connecting piece 50 and the gate 44, so that the gate 44 reaches its closed position.

If the valve is installed obliquely or horizontally, the restoring element 70 reliably ensures that the piston 49 is pushed back and the gate 4 moves into its closed position.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A gate valve, comprising:
a piston (49) which delimits a pressure chamber (61) within a housing (43);
a gate (44) for opening and closing a conveyor line (57), the gate (44) being connected to the piston (49); and
a switching valve (54) arranged in a pressure transmission line (60) between the conveyor line (57) and the pressure chamber (61),
wherein the switching valve (54), when open, releases a pressure connection between an interior of the conveyor line (57) and the pressure chamber (61), causing the gate (44) to be displaced into an open position via the piston (49).

2. The gate valve according to claim 1,
wherein the gate (44) is connected to the piston (49) via at least one connecting piece (50).

3. The gate valve according to claim 2,
wherein the at least one connecting piece (50) is a piston rod.

4. The gate valve according to claim 1,
wherein the pressure chamber (61) comprises at least one opening (63), and
wherein the at least one opening (63) is connected to the pressure transmission line (60) to which the switching valve (54) is connected.

5. The gate valve according to claim 1,
wherein the switching valve (54) is arranged within a valve housing (33).

6. The gate valve according to claim 1,
wherein a second pressure transmission line (56) is connected to the switching valve (54) and is provided for connection to the conveyor line (57).

7. The gate valve according to claim 1,
wherein the switching valve (54) is a solenoid valve.

8. The gate valve according to claim 1,
wherein a position of the gate (44) in the open position and/or in a closed position is monitored by limit switches (52, 53).

9. The gate valve according to claim 1,
wherein a restoring force acts on the piston (49) when the gate (44) is in the open position.

10. The gate valve according to claim 9,
wherein a pressure medium (64) is accommodated in the pressure chamber (61) and exerts the restoring force on the piston (49).

11. The gate valve according to claim 9,
wherein a compression spring is accommodated in the pressure chamber (61) and exerts the restoring force on the piston (49).

12. The gate valve according to claim 9,
wherein a restoring element (70) acts on the gate (44).

13. The gate valve according to claim 12,
wherein the restoring element (70) is an elastically stretchable or a weight-bearing pull rope.

14. A module for producing a conveyor line (5 to 12, 57) of a system for conveying bulk material, comprising:
a tube section (30) from which a tubular crosspiece (31, 32) branches off; and
the gate valve (14) according to claim 1 arranged in the tubular crosspiece (31, 32).

15. A system for conveying bulk material, comprising:
at least two senders (A to E) containing the bulk material; and
at least one receiver (1 to 3) receiving the bulk material, the at least two senders (A to E) being line-connected to the at least one receiver (1 to 3) by conveyor lines (5 to 12),
wherein the conveyor lines comprise a receiver collecting line (26) which has an upwardly running line section (10 to 12a) into which at least two transverse lines (13, 15 to 17, 14′, 15′ to 17′) open, and
wherein the gate valve (14) according to claim 1 is arranged in each of the at least two transverse lines (13, 15 to 17, 14′, 15′ to 17′) for opening and closing the line sections (10a to 13a).

16. The system according to claim 15,
wherein a draining suction module (27) is arranged at an end of the transverse line, which has no connection for a line coming from the sender (A to E).
